(19) United States
(12) Patent Application Publication
(10) Pub. No.: US 2008/0041206 A1
(43) Pub. Date: Feb. 21, 2008

(54) Edge of a cutting member for a cutter drum

(75) Inventors: Luigi Mergola, Bourg-De-Peage (FR); Annabelle Meilland, Grenoble (FR); Pascal Reyne, Chateuaneuf-De-Galaure (FR)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 11/785,575

(22) Filed: Apr. 18, 2007

(30) Foreign Application Priority Data
Jul. 10, 2006 (SE) 0601526-7

(51) Int. Cl. B23D 25/12

(52) U.S. Cl. 83/343

(57) ABSTRACT

A cutter drum for a rotary cutting apparatus comprises a substantially circular-cylindrical portion provided with at least one cutting member having a longitudinal extension, the surface thereof being divided into a body portion having a first and a second side portion, and a main edge portion between said first and second side portions and substantially across the longitudinal extension of the cutting member. In accordance with the invention, an intermediate portion having a predetermined radius is provided on each side of said main edge portion, said intermediate portion connecting said main edge portion directly or indirectly to said body portion.

The invention also relates to a rotary cutting apparatus comprising an anvil drum and such a cutter drum.

### TECHNICAL BACKGROUND OF THE INVENTION

The present invention relates to a cutter drum for a rotary cutting apparatus comprising a substantially circular-cylindrical portion provided with at least one cutting member having a longitudinal extension, the surface thereof being divided into a body portion having a first and a second side portion, and a main edge portion between said first and second side portions and substantially across the longitudinal extension of the cutting member.

The invention also relates to a rotary cutting apparatus comprising an anvil drum and such a cutter drum.

Such a cutter drum is known from JP 11-188698. Other cutter drums are known from JP 2001-269896 and JP 9-267 299. All of them reside in the drawback that the edge/edges of the cutting member are sharp. This is a major drawback, since, sharp edges require a surface roughness R_{A} on the top of the edge and on the sides that is less then 0.3 μm. Furthermore, sharp edges are fragile and may be chipped away, and may prevent cutting to be performed, requiring re-sharpening of the edge, in turn reducing the life time of the cutter drum as well as of the anvil drum.

### SUMMARY OF THE INVENTION

The object of the present invention is to improve the properties of the cutting member.

This object has been achieved by a cutter drum of the initially defined kind, which further comprises an intermediate portion having a predetermined radius is provided on each side of said main edge portion, said intermediate portion connecting said main edge portion directly or indirectly to said body portion.

Hereby is achieved a more robust edge. It furthermore allows higher surface roughness and increases the lifetime of the cutter drum. Surprisingly was also achieved a reduced cutting effort in the range of 20-40%. Furthermore, less pressure is needed during cutting of a web, due to a progressive pressure created by the defined shape.

### DRAWING SUMMARY

In the following, the invention will be described in more detail with reference to the accompanying drawings, in which

FIG. 1 is a lateral cross-section of a first embodiment of a cutting member of the rotary cutter drum of a rotary cutting apparatus.

FIG. 2 is a lateral cross-section of a second embodiment of the cutting member;

FIG. 3 is a lateral cross-section of a third embodiment of the cutting member;

FIG. 4 is a lateral cross-section of a fourth embodiment of the cutting member;

FIG. 5 is a lateral cross-section of a fifth embodiment of the cutting member;

FIG. 6 is a lateral cross-section of a sixth embodiment of the cutting member;

FIG. 7 is a lateral cross-section of a seventh embodiment of the cutting member;

FIG. 8 is a lateral cross-section of a eighth embodiment of the cutting member; and

FIG. 9 is a perspective view of a rotary cutting apparatus provided with a rotary cutter drum and a cutting member according to any one of FIGS. 1-8.

### DETAILED DESCRIPTION

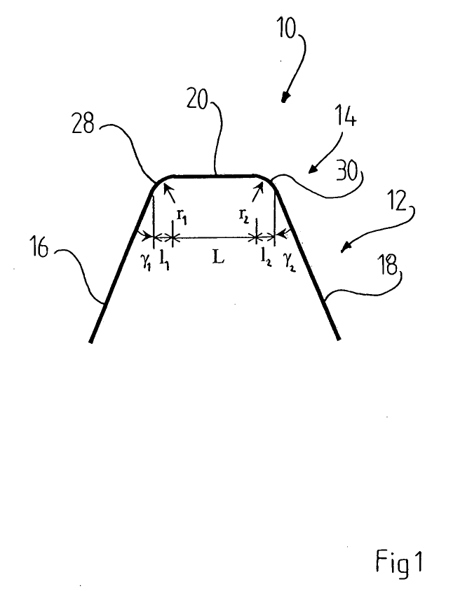

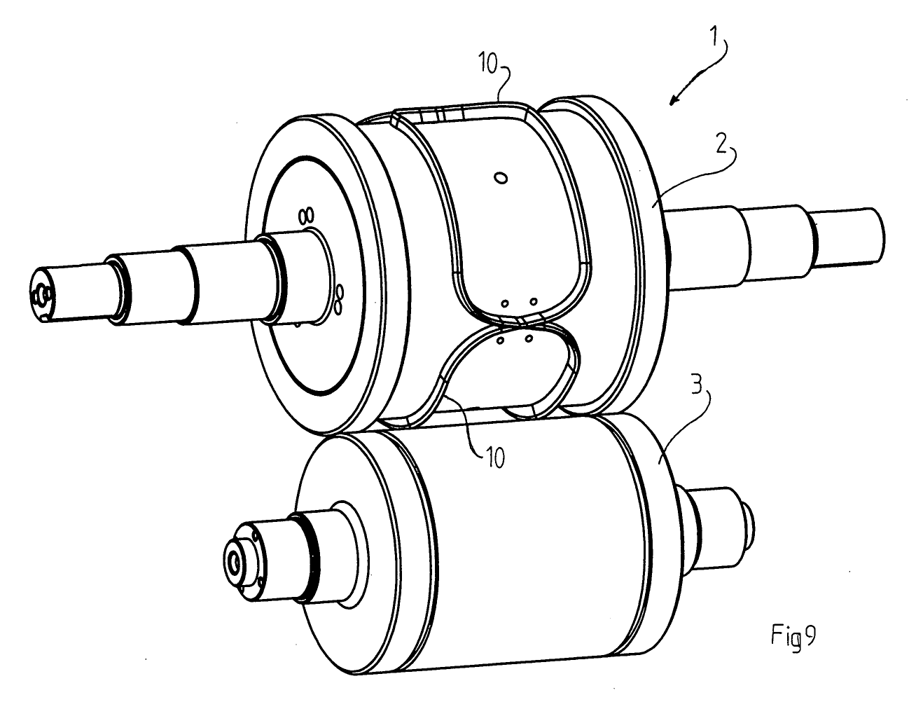

FIG. 1 is a cross-section of a cutting member 10 of a rotary cutter drum 2 (see FIG. 9). The cutting member 10 is provided with a body portion 12 and an edge portion 14. The body portion has on each side of it a first side portion 16 and a second side portion 18, whereas the edge portion 14 is provided with a main edge portion 20 and intermediate portions 28, 30 on each side of the main edge portion 20.

The main edge portion 20 is relatively linear, as seen in the lateral cross-section according to FIG. 1, and has a lateral extension L.

The lateral extension of the intermediate portions 28, 30 is denoted I₁ and I₂, respectively. The intermediate portions 28, 30 also have a curved surface of a desired radius r₁ and r₂, respectively.

The angle of the side surfaces 16, 18 with respect to a radial plane of the cutter drum 2 is denoted γ₁ and γ₂, respectively.

The shape of this cutting member is symmetrical, for which reason I₁=I₂; r₁=r₂ and γ₁=γ₂.

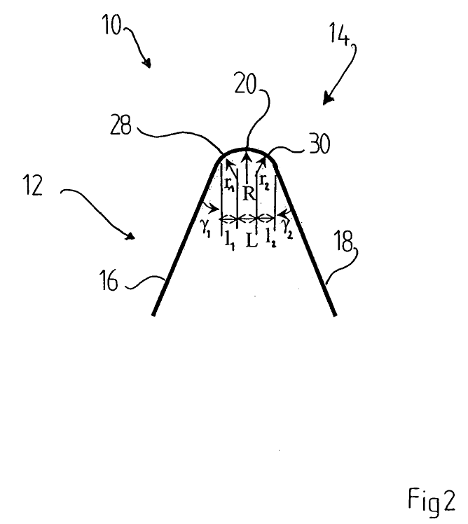

FIG. 2 illustrates a second embodiment, which is very similar to that of the first embodiment, however being different in the main edge portion 20 is curved between the intermediate portions 28, 30. The curved main edge portion has a radius R.

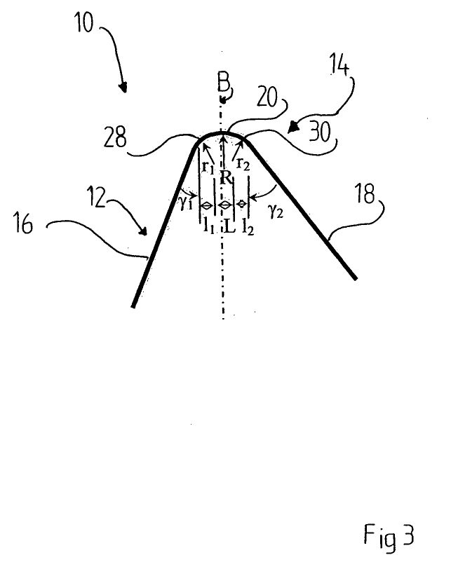

FIG. 3 illustrates a third embodiment, which in turn is very similar to that of the second embodiment. The difference lies however in a non-symmetrical shape of the cutting member 10. The broken line B in FIG. 3 is a centre line in case of symmetry.

Accordingly, the angle γ₂ is larger than γ₁, causing the first side portion 16 to have a steeper slope than the second side portion 18. Furthermore, the second radius r₁ of the second intermediate portion is smaller than the radius r₂ of the first intermediate portion, and the lateral extension I₁ of the second intermediate portion 30 is larger than the lateral extension I₂ of the first intermediate portion 28.

It should however be noted that it would be possible that I₁=I₂ and that r₁=r₂.

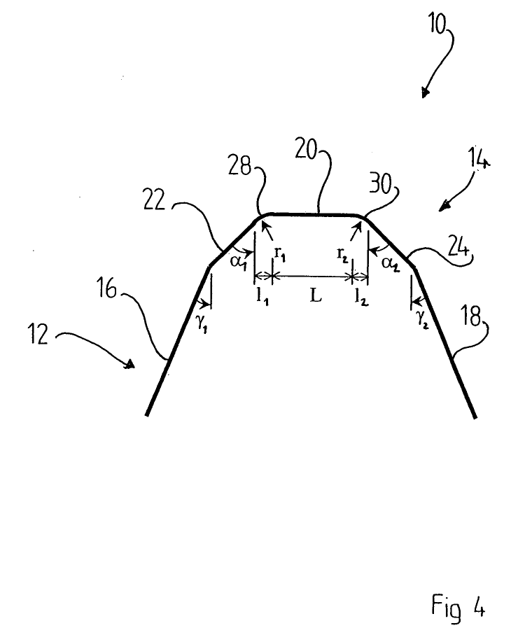

FIG. 4 illustrates a fourth embodiment, according to which the edge portion 14 is not only provided with the first and second intermediate portion 28, 30 on each side of the main edge portion 20, but also with a first side edge portion 22 between the first intermediate portion 28 and the first side portion 16, and with a second side edge portion 24 between the second intermediate portion 30 and the second side portion 18.

As in the previous embodiments, the angle of the side surfaces 16, 18 with respect to a radial plane of the cutter drum 2 is denoted γ₁ and γ₂, respectively.

Furthermore, the angle of the first and second side edge portions 22, 24 with respect to a radial plane of the cutter drum 2 is denoted α₁ and α₂, respectively.

The shape of this cutting member is symmetrical, for which reason I₁=I₂; r₁=r₂; γ₁=γ₂ and α₁=α₂.

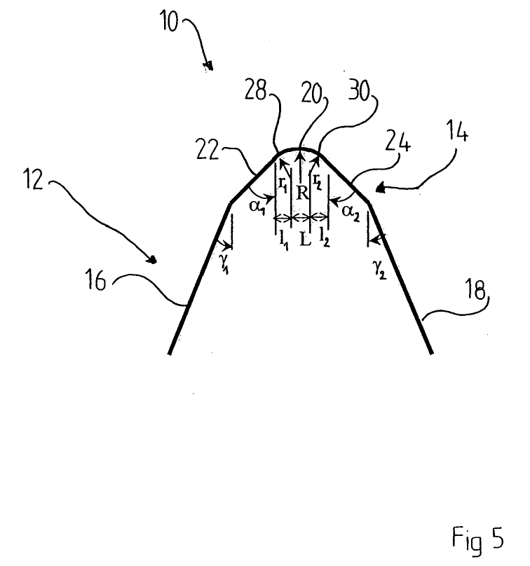

FIG. 5 illustrates a fifth embodiment, which is very similar to that of the fourth embodiment, however being different in the main edge portion 20 is curved between the intermediate portions 28, 30. The curved main edge portion has a radius R.

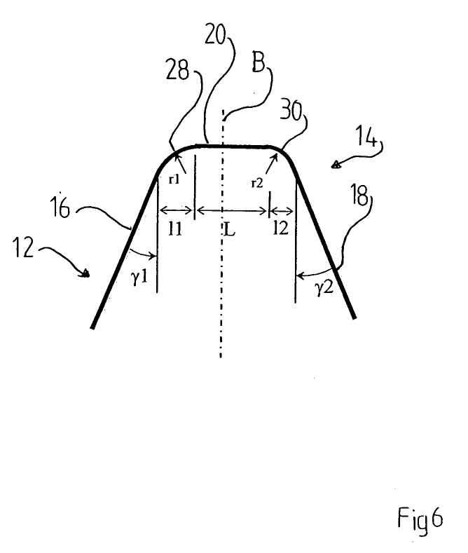

FIG. 6 illustrates a sixth embodiment, which is very similar to that of the first embodiment. The difference lies however in a non-symmetrical shape of the cutting member 10. The broken line B in FIG. 6 is a centre line in case of symmetry.

Accordingly, the main cutting edge 20 is not arranged centrally, but the lateral extension L thereof is pushed to the right. Furthermore, angle γ₂ is larger than γ₁, causing the first side portion 16 to have a steeper slope than the second side portion 18. Furthermore, the second radius r₁ of the second intermediate portion is smaller than the radius r₂ of the first intermediate portion, and the lateral extension I₁ of the second intermediate portion 30 is larger than the lateral extension I₂ of the first intermediate portion 28.

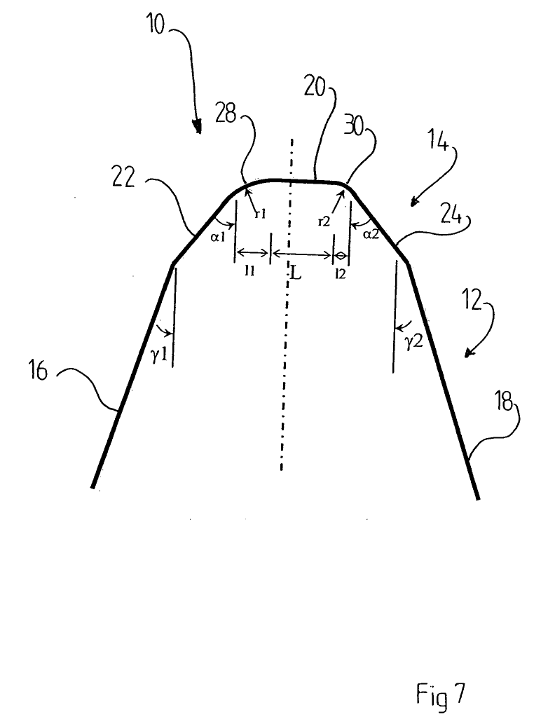

FIG. 7 illustrates a seventh embodiment, which is very similar to that of the sixth embodiment, i.e. what is stated in connection with the embodiment of FIG. 6 regarding the relationships of I₁, I₂, r₁ and r₂ also relates to the embodiment of FIG. 7. It is however different in that the edge portion 14 is not only provided with the first and second intermediate portion 28, 30 on each side of the main edge portion 20, but also with a first side edge portion 22 between the first intermediate portion 28 and the first side portion 16, and with a second side edge portion 24 between the second intermediate portion 30 and the second side portion 18.

The angle of the first and second side edge portions 22, 24 with respect to a radial plane of the cutter drum 2 is denoted α₁ and α₂, respectively, and α₂>α₁.

For the corresponding reasons as those relating to the embodiment of FIG. 6, γ₂>γ₁. On the other hand, even though α₂>α₁, it is possible in the embodiment of FIG. 7, that γ₂>γ₁.

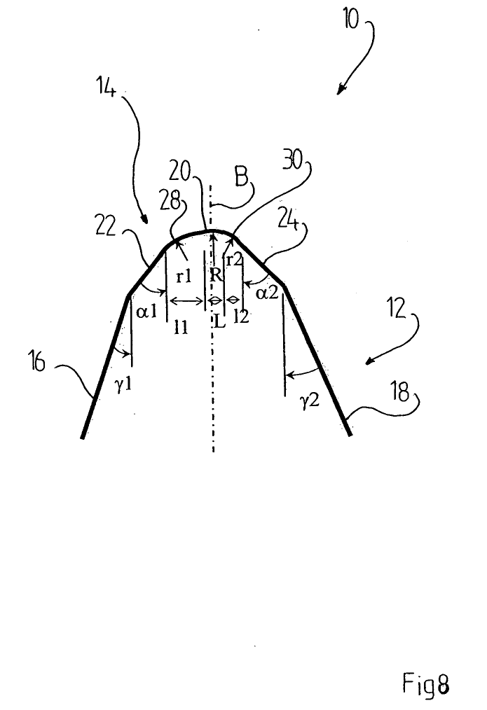

FIG. 8 illustrates an eighth embodiment, which is very similar to that of the seventh embodiment, i.e. what is stated in connection with FIG. 7 regarding the angles and the lateral extensions also relates to the embodiment of FIG. 8. It is however different in that the main edge portion 20 is curved between the intermediate portions 28, 30. The curved main edge portion has a radius R.

In all the above embodiments the following ranges are suitable:

### L=10-60 μm

### R=10-80 μm

### I₁=5-50 μm

### I₂=5-50 μm

r₁=5-50 μm
r₂=5-50 μm

FIG. 9 illustrates a rotary cutting apparatus 1 provided with a rotary cutter drum 2 and an anvil drum 3 in cutting relationship with one another, for which reason the rotary cutter drum is provided with one or more cutting members 10, having the shape of articles to be cut from a web introduced between the rotary cutter drum 2 and the anvil drum 3.

It has surprisingly been proven that the cutting effort was reduced in the range of 20-40% by means of the cutter drum according to the invention.

Furthermore, a more robust edge than according to the prior art was achieved.

Yet furthermore a better surface roughness was achieved, which in turn increases the lifetime of the cutter drum.

The cutting member 10 according to any one of the above embodiments can be manufactured by grinding a non-shaped member protruding substantially radially from the cutter drum by means of e.g. a diamond wheel shaped to a rounded form, for creating the rounded shape according to the invention. Alternatively, the cutting member is first provided with e.g. sharp edges. The edges are then treated by brushing or by sputtering of abrasive particles for achieving the desired widths and radii of the edges.

Prior art cutting members having sharp edges on either sides of a flat surface, causes the fibre material of the web to be pressed against the anvil. The flat surface and sharp edges prevent the fibre material from escaping laterally away from the edges. This requires a high applied pressure and two cuts on each side of the flat surface, i.e. the compressed portion will be cut along the two sharp edges.

The cutting member according to the invention will instead allow the compressed material to move side-wards, depending on the fact that the rounded edges will create a progressive pressure on the web, and will surprisingly cause the web to tear somewhere between the rounded edges 28, 30 at less pressure than what is the case regarding the prior art cutting members having sharp edges.

This progressive pressure is enhanced by the first and second side edge portion 22, 24.

1: A cutter drum for a rotary cutting apparatus comprising a substantially circular-cylindrical portion provided with at least one cutting member having a longitudinal extension, the surface thereof being divided into a body portion having a first and a second side portion, and a main edge portion between said first and second side portions and substantially across the longitudinal extension of the cutting member, wherein an intermediate portion having a predetermined radius is provided on each side of said main edge portion, said intermediate portion connecting said main edge portion directly or indirectly to said body portion.

2: A cutter drum according to claim 1, wherein said main edge portion has a predetermined width across the longitudinal extension of the cutting member.

3: A cutter drum according to claim 1, wherein the intermediate portion has a predetermined extension substantially across the longitudinal extension of the cutting member.

4: A cutter drum according to claim 1, wherein the radius provided on each side of said main edge portion are substantially the same.

5: A cutter drum according to claim 1, wherein the radius provided on each side of said main edge portion are different.

6: A cutter drum according to claim 2 wherein the extension of the intermediate portions are substantially the same.

7: A cutter drum according to claim 2, wherein the extension of the intermediate portions are different.

8: A cutter drum according to claim 1, wherein said intermediate portion interconnects said main edge portion with said first and second side portions.

9: A cutter drum according to claim 7, wherein said intermediate portion interconnects said main edge portion with said first and second side portions at a predetermined angle in relation to a radial plane through the cutter drum and perpendicular to the longitudinal extension of the main edge portion.

10: A cutter drum according to claim 9, wherein the angles of the interconnection of main edge portion with said first and second side portions are substantially the same.

11: A cutter drum according to claim 9, wherein the angles of the interconnection of main edge portion with said first and second side portions are different.

12: A cutter drum according to claim 1, wherein the main edge portion is substantially straight across the longitudinal extension of the cutting member.

13: A cutter drum according to claim 1, wherein the main edge portion is substantially arched and has at least partly a predetermined radius across the longitudinal extension of the cutting member.

14: A cutter drum according to claim 1, wherein a first side edge portion and a second side edge portion are provided, said first side edge portion interconnecting said main edge portion with said first side portion, said second side edge portion interconnecting said main edge portion with said second side portion, said intermediate portion interconnecting said main edge portion with said first side edge portion and second side edge portion, respectively.

15: A cutter drum according to claim 14, wherein said first and second side edge portion connects to the first and second side portions at a predetermined angle in relation to a radial plane through the cutter drum and perpendicular to the longitudinal extension of the main edge portion.

16: A cutter drum according to claim 14, wherein first and second side edge portion connects to the main edge portion at a predetermined angle, respectively, in relation to a radial plane through the cutter drum and perpendicular to the longitudinal extension of the main edge portion.

17: A cutter drum according to claim 14, wherein the angles of the interconnection of main edge portion with said first and second side portions are substantially the same.

18: A cutter drum according to claim 15, wherein the angles of the interconnection of main edge portion with said first and second side portions are different.

19: A cutter drum according to claim 16, wherein the angles of the first and second side edge portion and the main edge portion are substantially the same.

20: A cutter drum according to claim 16, wherein the angles of the first and second side edge portion and the main edge portion are different.

21: A rotary cutting apparatus comprising an anvil drum and a cutter drum according to claim 1.

22: A cutter drum according to claim 15, wherein first and second side edge portion connects to the main edge portion at a predetermined angle, respectively, in relation to a radial plane through the cutter drum and perpendicular to the longitudinal extension of the main edge portion.

23: A cutter drum according to claim 15, wherein the angles of the interconnection of main edge portion with said first and second side portions are substantially the same.

24: A cutter drum according to claim 16, wherein the angles of the interconnection of main edge portion with said first and second side portions are substantially the same.
